(19) United States
(12) Patent Application Publication
(10) Pub. No.: US 2003/0163392 A1
(43) Pub. Date: Aug. 28, 2003

(54) Bartering protocol language

(75) Inventors: Dwip N. Banerjee, Austin, TX (US); Rabindranath Dutta, Los Angeles, CA (US); Kumar Ravi, Cedar Park, TX (US); Eduardo N. Spring, Round Rock, TX (US)

Correspondence Address: Intellectual Property Law Dept., IBM Corporation, 11400 Burnet Road, Austin, TX, 78758, US

(73) Assignee: International Business Machines Corporation, Armonk, NY

(21) Appl. No.: 10/087,954

(22) Filed: Feb. 27, 2002

(51) Int. Cl. G06F 17/60

(52) U.S. Cl. 705/27

(57) ABSTRACT

A system, method and program of the invention enables bartering to be carried out over a network of computer systems. A specific bartering protocol language enables a specification of a needs list of needed items that a user desires to acquire and a specification of an availability list of available items that a user desires to use in trading for one or more of the needed items. Each needed item can be associated with a priority indicating a level of priority that a user has in acquiring the needed item. The needs list may also contain a range of near equivalent items having an associated priority indicating a user's desire to accept a given near equivalent item in lieu of a given needed item. The system performs a search of available items for a match with each of the needed items based upon the needed item's priority wherein the higher priority items are attempted to be matched before lower priority items are matched. The searching is performed first within a same bartering system and performed second across a different bartering system if no match is found during the search within the same bartering system.

### BACKGROUND OF THE INVENTION

1. Field of the Invention

This invention relates to buying and selling items over a network, and more specifically to a system, method and program incorporating a bartering protocol language for specifying bartering features across different bartering systems.

2. Description of the Related Art

The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.).

The Internet is widely used for many activities including commercial transactions, such as between retailers and end-users, auction sites, and bartering systems that enable the buying and selling of items amongst end-users. One such bartering system enables an end user to sell a desired item owned by the user and to receive “barter” dollars provided by the bartering site; and to buy items owned by other users by using bartering dollars. The end user has an account with the bartering site that contains the barter dollars that can be used to buy and sell items. This approach works well when a user performs all of the user's transactions, i.e., buying, selling, trading, within a same bartering site. However, if a user buys from one site, and sells items through another bartering site, the user must undertake two separate transactions. With such multiple transactions, time delays may become an issue when crediting and debiting one or more user accounts.

### SUMMARY OF THE INVENTION

It is therefore an object of this invention to enable a bartering process to match items that a user would like to buy with items that others would like to sell, and to match items that a user would like to sell with items that others would like to buy; whereby one or more items that a user would like to buy are matched in terms of equivalency with one or more items that a user would like to sell, without necessarily utilizing an intermediate value mechanism such as bartering dollars; thereby enabling the bartering process to be compatible across multiple bartering systems.

It is a further object of the invention to enable a user specified priority for items that the user would like to buy and sell.

It is a further object of the invention to specify a range of near equivalency amongst non-identical barter items.

It is a further object of the invention to enable a bartering process to match items that a user would like to buy with items that others would like to sell, and to match items that a user would like to sell with items that others would like to buy; whereby the matching process occurs according to a priority assigned by the user to the items or choices.

It is a further object of this invention to enable a bartering process to be compatible across multiple bartering sites.

A bartering protocol system of a preferred embodiment of the invention has a specification of a needs list and an availability list for each of its members, i.e., users. The needs list specifies the items that the user would like to acquire. The availability list specifies the items that the user is willing to make available to others for barter, trade, or purchase, especially in conjunction with acquiring an item on the needs list. The system enables a user to specify a priority for individual items or groups of items in the needs list. The system, method and program of this invention enables a process for finding a match, based on a specified priority, for items on the needs list with items that others may have for sell as indicated on the availability lists of others. Furthermore, the process matches items on the user's availability list with items that others may have a need for as indicated on the needs list of others.

The barter protocol language enables a specification of near equivalency between items that are desired to be bought and sold that will be satisfactory to the end user. The protocol language enables a user to specify the types of items that will suffice for, or be accepted in lieu of, another item.

As such, the protocol language enables a user to prioritize their needs. An item that a user greatly needs to have may have a higher priority than an item that the user thinks would be nice to have, but does not necessarily have to acquire. This prioritization may reflect a higher “price” in terms of real currency, barter dollars, or equivalently matched items, that the user is willing to pay for items that the user greatly desires or must have. As such, the scheme of prioritization in the barter protocol language allows the ability to specify these priorities.

In the protocol language of the present invention, equivalency of dissimilar items can be specified, also. For example, a user desiring to acquire a certain make, model, and year of an automobile can specify a specific service or skill that the user can provide, such as renovating a room in a home, as an available item that is equivalent to the needed item. If a user has a specific skill that the user wants to trade for a specific needed item, the protocol language of the present invention can provide for such a match within a bartering site or across multiple bartering sites. The protocol language allows the specification of equivalence between dissimilar items without the necessity of reducing each item to a quantity of barter dollars. This allows a specification of a very clear and unambiguous match.

More specifically, a preferred embodiment of the protocol language is written in XML. XML enables the creation of interdependencies between items. As such, the features of the XML protocol language include enabling a specification of a needs list and an availability list, a specification of equivalency and near equivalency of items, a specification of equivalency of dissimilar items, a prioritization of requirements or needs, and an inter-translation between different protocol languages of different bartering sites, i.e., allowing cross-bartering across different bartering systems where different bartering languages are bridged through a translator.

### BRIEF DESCRIPTION OF THE DRAWINGS

For a more complete understanding of the present invention and the advantages thereof, reference should be made to the following Detailed Description taken in connection with the accompanying drawings in which:

FIG. 1 depicts one embodiment of a computer system with which the method, system, and program of the present invention may be advantageously utilized;

FIGS. 2A-2D illustrates an XML bartering protocol, of a preferred embodiment of the invention, having an availability list and a needs list in which choices for desired items are prioritized for exchange for an available item on the availability list, and the individual items on the needs list are further prioritized;

FIGS. 2E-2G illustrate a different representation of the XML bartering protocol format of FIGS. 2B-2D wherein the capability of translating the specification into different formats when bartering across bartering domains is illustrated in accordance with a preferred embodiment of the invention;

FIG. 3 is a flow diagram of the process and logic utilized in specifying an availability list and a needs list in accordance with a preferred embodiment of the invention; and

FIG. 4 is a flow diagram of the process and logic utilized in finding a match, if at all, for a user specified availability list and a user specified needs list in accordance with a preferred embodiment of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

The system of the present invention may be any one of a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

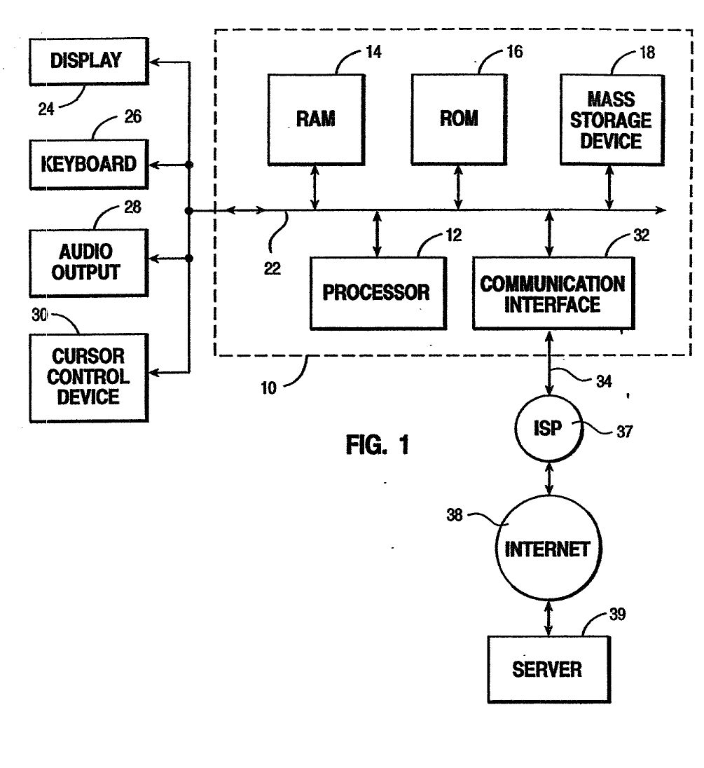

Referring now to the drawings, and in particular to FIG. 1, there is depicted one embodiment of a computer system with which the method, system, and program of the present invention may be advantageously utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

Processor 12 may be a general-purpose processor such as IBM's PowerPC™ processor that, during normal operation, processes data under the control of operating system and application software stored in a dynamic storage device such as a random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts described herein. Alternatively, the steps of the present invention might be performed by specific hardware components that contain hardwire logic for performing the steps, or by any combination of programmed computer components and custom hardware components.

Further, multiple peripheral components may be added to computer system 10. For example, a display 24 is also attached to bus 22 for providing visual, tactile or other graphical representation formats. Audio output through a speaker or other audio projection device may be controlled by audio output device 28 attached to bus 22. A keyboard 26 and cursor control device 30, such as a mouse, track ball, or cursor direction keys, are coupled to bus 22 as interfaces for user inputs to computer system 10. It should be understood that keyboard 26 and cursor control device 30 are examples of multiple types of input devices that may be utilized in the present invention. In alternate embodiments of the present invention, additional input and output peripheral components may be added.

The present invention may be provided as a computer program product, included on a machine-readable medium having stored thereon the machine executable instructions used to program computer system 10 to perform a process according to the present invention. The term “machine-readable-medium” as used herein includes any medium that participates in providing instructions to processor 12 or other components of computer system 10 for execution. Such a medium may take many forms including, but not limited to, nonvolatile media, volatile media, and transmission media. Common forms of nonvolatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide are network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communications interface 32, which carry the digital or analog data to and from computer system 10, are exemplary forms of carrier waves transporting the information.

A bartering protocol system of a preferred embodiment of the invention has a specification of a needs list and an availability list for each of its members, i.e., users. The needs list specifies the items that the user would like to acquire. The availability list specifies the items that the user is willing to make available to others for barter, trade, or purchase, especially in conjunction with acquiring an item on the needs list. In a preferred embodiment, the needs list includes a user specified priority for each item, or group of items. The priority indicates the level of desire or need that the user has in acquiring the item(s). A match is found, based on the specified priority, for one or more items on the needs list with items available for trade or sell as specified on the availability lists of others.

The system, method, and program of this invention provides a barter protocol language that incorporates elements that are unique to bartering. One such element includes specifying the equivalence or near equivalence of items. For example, if a user wishes to acquire a round table that seats twelve (12) people, and the user finds a round table that seats twelve, the two items would be considered equivalent. However, if the user could not find such a round table that seats twelve people, the user may be willing to consider a rectangular table that seats 14 people. This rectangular table may be considered a near equivalent. Although the end user may consider a rectangular table that only seats ten people, this type of table would have a lower priority than the other equivalent table and near equivalent table previously described.

The protocol language specifies equivalence and near equivalency between items that are desired to be bought and sold that will be satisfactory to the end user. The protocol language enables a user to specify the types of items that will suffice for, or be accepted in lieu of, another item.

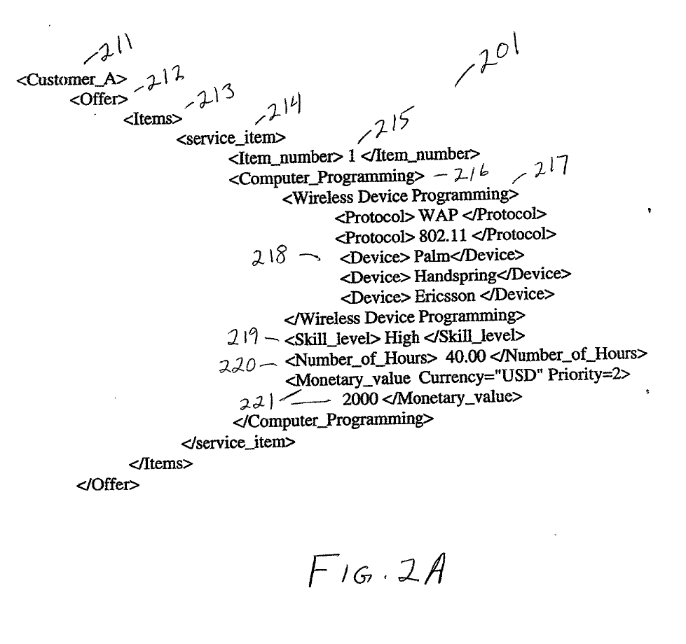

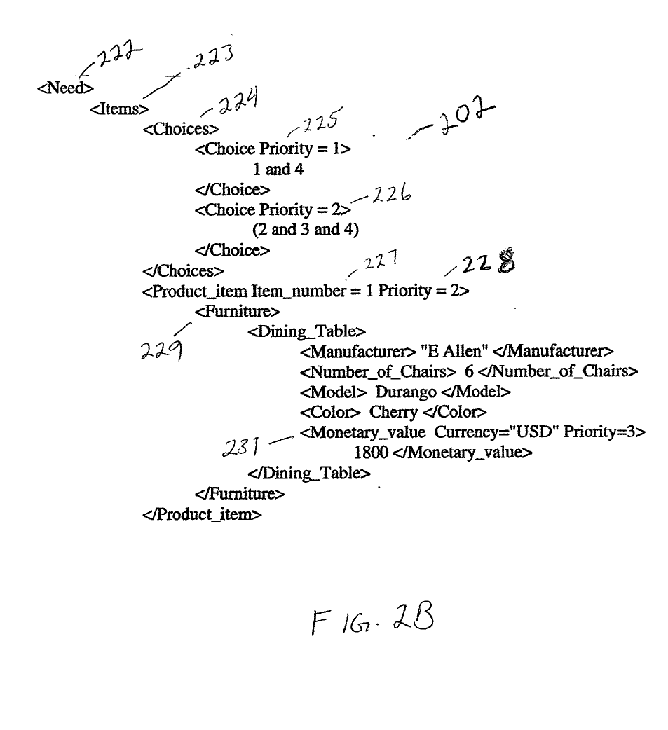

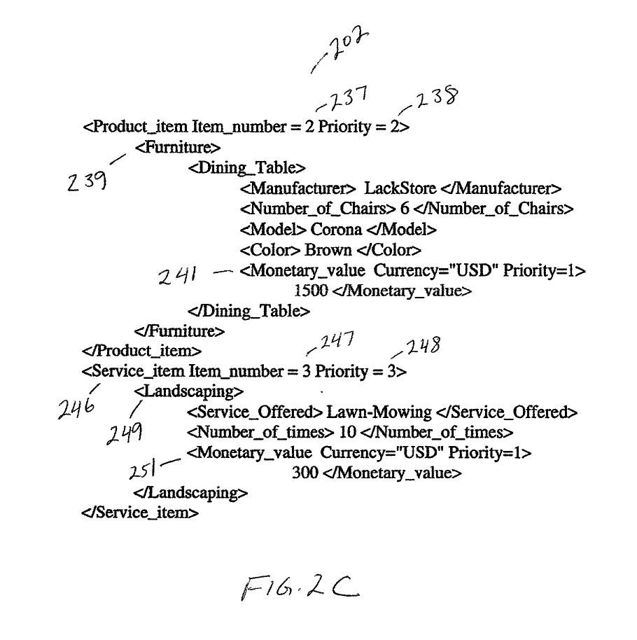

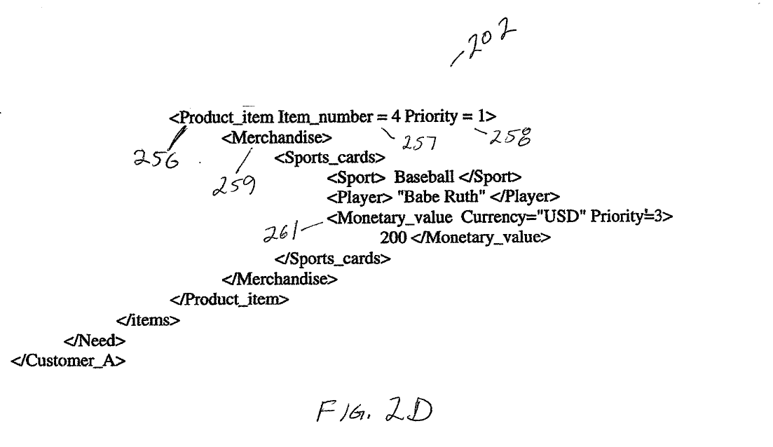

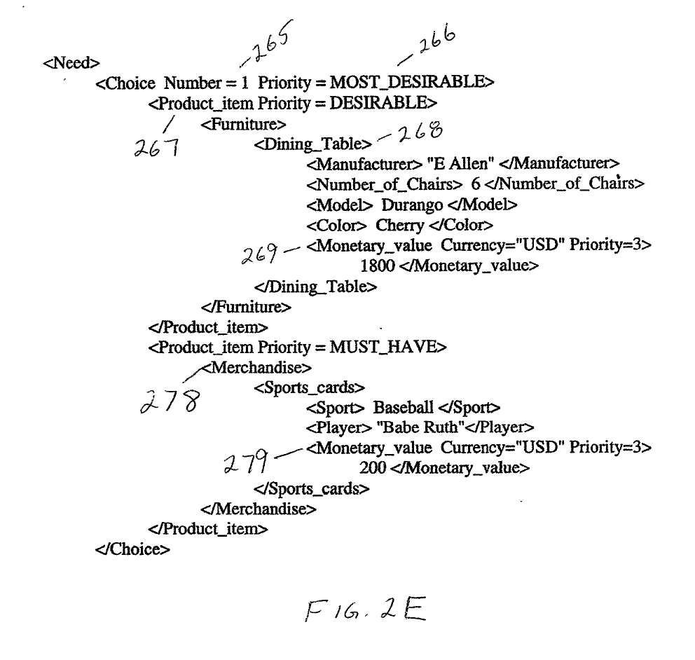

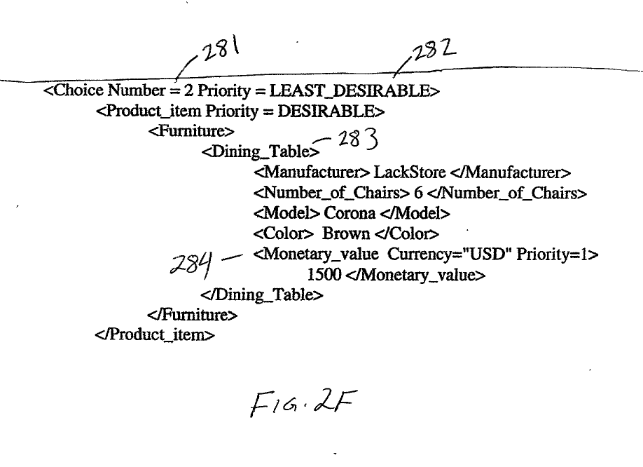

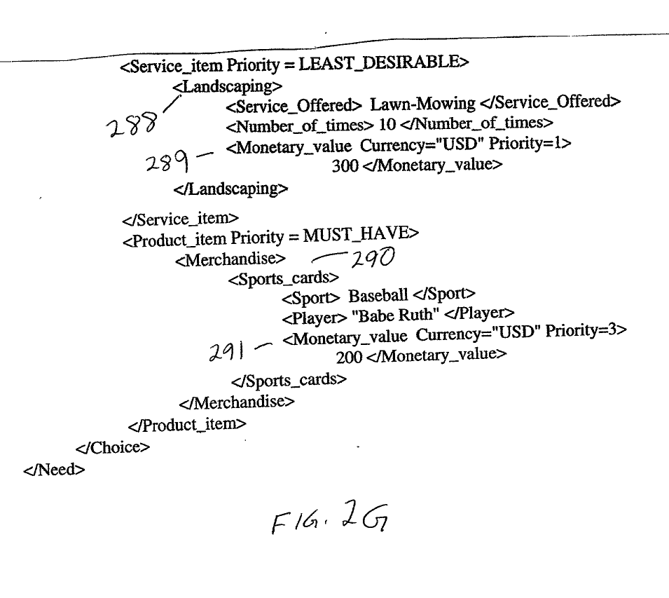

FIGS. 2A-2G represent an example of an XML barter protocol language that has its own corresponding document type definition (DTD) which may be unique to a particular barter club.

FIGS. 2A-2D illustrate a barter protocol language that represents a user's availability list and a needs list. More specifically, as an example, a computer programming service is being bartered for an antique dining table. In this example, depending upon the dining room table manufacturer, the user would settle for a more exquisite or lesser value table. Note that if the user's first choice is not available, the user would be willing to settle for a combination of multiple items. In the needs list 202 of FIGS. 2B-2D, the choices are represented in one way of a preferred embodiment.

In FIG. 2A, a computer programming service 216 of wireless device programming 217 is being listed as a first item 215 under a service item 214 of items 213 that the customer 211 is offering 212 or making available under the customer's availability list 201 as the item 217 that the customer wants to use to trade or barter with in order to acquire other items on the customer's needs list. Items 213 can be physical or nonphysical items. In this example, item 213 is a nonphysical item, i.e., a service. The service item 214 indicates a service to be provided, instead of a physical item, for trade. Such services can be monetarily very valuable. The bartering protocol pulls in the appropriate document type definitions (DTDs) 218 that further specifies the service being offered. It is expected that each category (e.g., a skilled programming category under a service item) will have its domain specific DTD representation to unambiguously quantify and interpret the attributes characteristic of its domain. In this example, the skill level 219 being offered is rated as high, the number of hours 220 being offered is forty (40) hours, and the monetary value 221 is specified at 2000 US dollars.

In FIG. 2B, a needs list 202 is shown that specifies the customer's first choice 225 and second choice 226 for acquiring products or services under the user's needs 222. The choices 225, 226 can comprise multiple items. In this example, the customer's first choice 225 is to acquire items 1 and 4. If this is not possible, the customer would be willing to settle for the second choice 226 comprising of items 2 and 3 and 4. The bartering protocol language then specifies the first item 227 with a designated priority 228. The type of item 229 and its description are then specified. In this case a product item (furniture) is being described with its own specific attributes. A monetary value 231 is associated with the specified item.

In FIG. 2C, the second item 237 is specified with its own priority 238 and its description 239. A monetary value 241 is associated with the specified item. The third item 247 is specified as a service item 246 as compared with the previous items that were specified as product items. The service item is assigned its own priority 248 and description 249. A monetary value 251 is associated with the specified service item 247.

In FIG. 2D, the fourth item 257, which is part of both the first choice 225 and the second choice 226 of FIG. 2B, is specified as a product item 256 having a “must have” or one (1) rated priority 258. The merchandise is further specified 259 along with an associated monetary value 261.

As described above, the barter protocol language enables a specification of a needs list and an availability list. In a preferred embodiment both groups of items, referred to herein as choices, and individual items can be specified with a priority to indicate a level of need that a user has in acquiring the item(s). Furthermore, equivalency amongst dissimilar items in the needs list and availability list can be specified. For example, equivalency of dissimilar items amongst the availability list and the needs list is shown with respect to programming services 216, FIG. 2A, as indicated by monetary value 221, and a combination of dissimilar items in either choice 1 or choice 2 through the respective monetary values as shown in FIGS. 2B-2D. As such, the bartering system of the present invention will attempt to find a match in terms of equivalency with what the user has available to sell with what the user wants to buy. That is, the barter protocol language enables a user to specify the types of one or more available items that can be used in consideration for one or more needed items even if the available items and needed items are dissimilar in kind and quantity.

Furthermore, near equivalency amongst non-identical individual items, or groups of items, i.e., choices, within a given availability list or a given needs list can be specified. More specifically, choice 2, i.e., the combination of items 2, 3, and 4 are indicated as being near equivalent to choice 1, i.e., the combination of items 1 and 4. The near equivalence is indicated by the combination of items within each choice, the combined monetary value assigned to each individual item, and more importantly, the priority assigned to the choice. Although the combined monetary values are equivalent, the difference in priority indicates that, from the user's perspective, the choices are near equivalent and not exactly equivalent. The lower priority choice would be accepted as being equivalent only if a match for the higher priority choice could not be found.

Furthermore, the protocol language addresses the situation where different bartering systems have different notions of specifications. For example, Bartering Club A may have one way of specifying equivalent items, requirements, and availability of items; while Barter Club B has a different way of specifying these. A member of Barter Club A may have already specified items corresponding to the member's needs in the protocol language of Barter Club A. However, if that same member wants to interact with Barter club B, such as by seeing if the member's needed items are available through Barter Club B; the member must utilize a different protocol language. As such, a bridge that enables a translation of the requirements in Barter Club A to the requirements of Barter Club B, such that there is a clear and unambiguous specification of the member's needs even in the language of Barter Club B is provided. The needs requirements would thus be understood by both Barter Club A and Barter Club B in order for items in Barter Club B to satisfy the needs of a member of Barter Club A. The inter-translation between differing protocols of various Barter Clubs enables cross-bartering across different bartering systems.

In FIGS. 2E-2G, the needs list 202 of FIGS. 2B-2D is represented differently. This illustrates another feature of the present invention. That is, translating the specification into different formats when bartering across bartering domains. This situation may arise, for example, when bartering is done across country boundaries or across different bartering organizations, which may adhere to different representations of the same items.

As shown in FIG. 2E, the choices, the first choice 265 (FIG. 2E) and the second choice 281 (FIG. 2F) themselves, are given a priority 266, 282 respectively instead of prioritizing the individual items that make up those choices as shown in FIGS. 2B-2D. As shown in FIGS. 2E-2G, the choices then comprise the items that make up those choices. For example, as shown in FIG. 2E, the first choice 265 comprises the dining table 268 as described, and having monetary value 269, and the sports cards 278 having monetary value 279 as specified. As shown in FIGS. 2F and 2G, the second choice 281 comprises three different items 283, 288, 290. These items comprise dining table 283 having a specified monetary value 284, landscaping service 288 having a specified monetary value 289, and sports cards 290 having a specified monetary value 291.

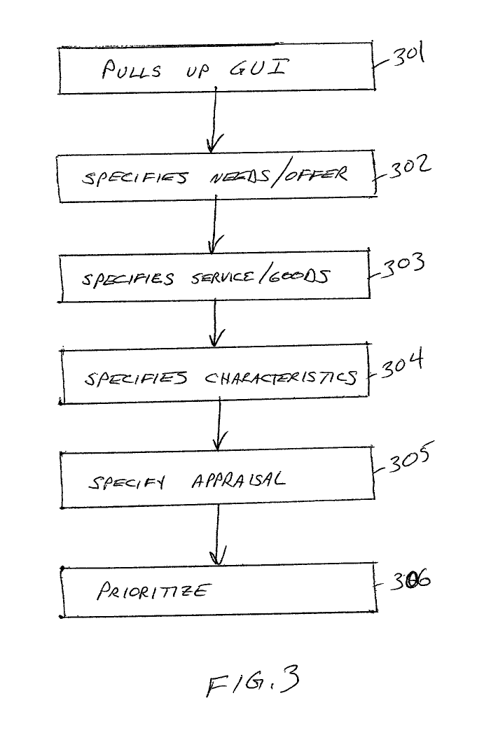

FIG. 3 is a flow diagram of the process and logic utilized in specifying an availability list and a needs list in accordance with a preferred embodiment of the invention. First, a user pulls up a graphical user interface (GUI) 301, and specifies whether the user is specifying items for a needs list or items for an offer or availability list 302. For each needs and availability list, the user selects the category as either service or merchandise 303, accordingly. Based upon the previous selection, the user specifies the characteristics for each service or merchandise item specified, 304. A possible monetary value is also specified 305 for each item. One embodiment of the invention may utilize an appraisal engine that performs the monetary value specification automatically or is utilized by the user as a tool. The appraisal engine may use various references for consultation such as blue book values, manufacturer list prices in catalogs, etc. A rating agency may make the values for various described items available to a user or to the bartering system through online connections to the rating agency or through an accessible database of items and values. The monetary value may also be specified according to the user's own appraisal. In a preferred embodiment, if no value is given by the user, the bartering system automatically assigns a common value through an acceptable rating agency, e.g., a blue book value.

The user then gives the described item a prioritization 306. In a preferred embodiment, the prioritization is indicated by a ranking such as 1, 2, 3, or 4. The prioritization indicates the level of desire that a user has in acquiring an item on the needs list. In other embodiments, prioritization may also be used to indicate the level of desire the user has in parting with an item on the user's availability list. Besides indicating priority by a ranking, priority can also be established through a user assessed value of the item. As such, the prioritization may represent what the user is willing to sell an item on the availability list for, or how important a particular item on the needs list is to the user. For example, if the user assessed value on the needs list is greater than the “appraised value”, then the item would be determined to be of high priority since the user is indicating that the user is willing to pay a higher price to acquire it. On the other hand, if the user assessed value on the needs list is less than the “appraised value”, then the item would be determined to be of a lower priority since the user is indicating that the user will only pay a lower price to acquire it. Likewise, a high user assessed value for an item on the user's availability list indicates that the item has a low priority on the user's availability list since the user will only trade or sell that item if the user receives higher than usual value for it. Likewise, a low user assessed value for an item on the user's availability list indicates that the item has a high priority on the user's availability list since the user is willing to off load the item for lower than usual value.

It should also be noted that in a preferred embodiment a priority field for the monetary value tag is utilized to create a monetary value priority indication. The priority field with the monetary value priority indication indicates how flexible the user is with regard to price. For example, if a user is looking for an item and is not willing to negotiate on the price, the user will specify this value to be 1. If the user is a little flexible on price, the value in the field may be a 2, and so forth. In another embodiment, if the user has no flexibility, the indicator may have a value of zero (0). If the user is willing to be flexible within 10% of the indicated price or monetary value, then the monetary value priority indicator may be 10 or some other value to represent 10% flexibility, etc.

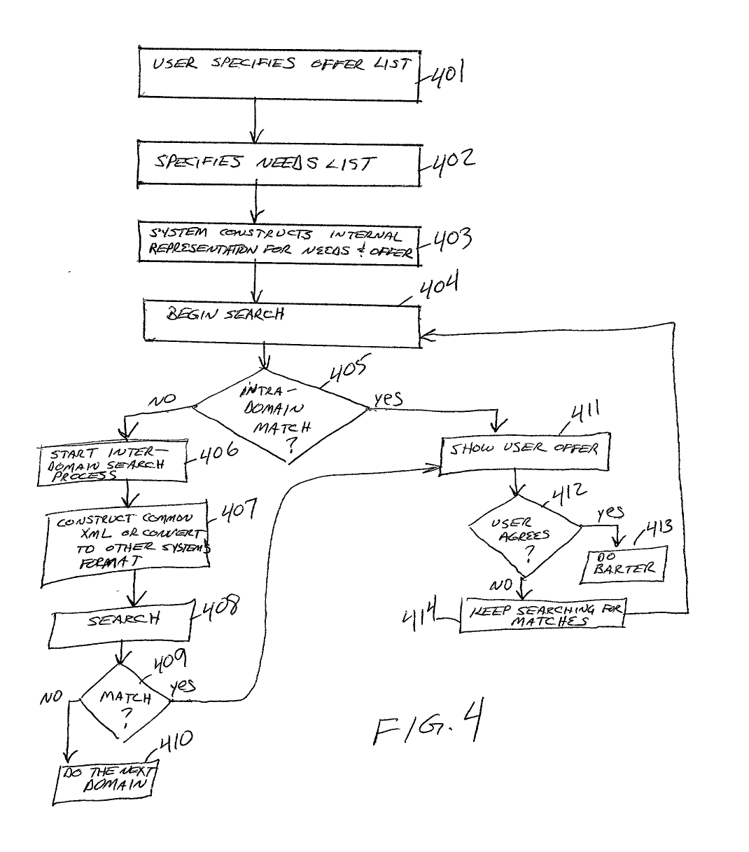

FIG. 4 is a flow diagram of the process and logic utilized in finding a match, if at all, for items in a user specified availability list and a user specified needs list in accordance with a preferred embodiment of the invention. The user specifies an offer list, i.e., an availability list, 401, and a needs list, 402. The system of the present invention then constructs an internal bartering protocol language, e.g., XML, of the needs list and availability list 403.

When complete, or when indicated by the user to do so, the system starts looking for a match, 404. The system looks up the user's availability list and needs list and determines a priority of the choices and or a priority of individual items in the lists. The system searches the availability lists of others to determine if an item on another availability list matches an item on this user's needs list beginning with the higher priority indicated need. Likewise, the system searches the needs lists of others to determine if an item on another needs list matches an item on this user's availability list. If there is a direct match, or one offer matches a combination of needs, or one need matches a combination of offers, a direct match has been found. If a direct match has not been found, a chain of offers and corresponding needs is constructed that satisfies these offers. Thus, the matching may not be a direct one-to-one corresponding match. For example, a match may indicate that user A desires an item that is listed under user B's availability list; user B desires an item that is listed under user C's availability list; and user C desires an item that is listed under user A's availability list.

In a preferred embodiment of the invention, the bartering system will attempt to match the higher priority items before attempting to find a match for the lower priority items. In other embodiments, all of the matching is performed at the same time. The results, however, are presented to the user such that the results for the higher priority items are presented first. Every matching attempt will be made for the higher priority items regardless of whether the matching effort results in direct matching, chaining, or utilizing cross domain searching and matching.

As such, during the matching process, the process first tries to perform the matching within its own bartering domain, i.e., the system looks first for an intra domain match, 405. If there is such an intra domain match, the system shows the user the offers found that match the user's needs list, and the needs of others that match the user's availability list, 411. The system then queries the user through a GUI whether or not the user agrees to the found match, 412. If the user indicates agreement or approval, the bartering transaction takes place, 413. If the user indicates that the user does not want to accept the found match, the system keeps searching for a match within that domain, 414, unless an indication is received from the user through the GUI to stop searching. If the user does not indicate that searching should stop, then the searching continues from step 414 to step 404.

If the intra-domain searching is exhausted without a further match, 405, then an inter domain matching process is instituted 406. For different bartering systems, the representations of the needs list and the availability list may be different. The system either constructs a common XML representation of the needs list and availability list with the item priorities, or the system converts the user's needs list and availability list to the other system's format, 407. Searching continues across other bartering domains, 408. If there is no match, then the system goes to a next bartering domain to search, 410.

If there is a complete match, processing continues by showing the user the offer, 411. Processing continues as previously described with respect to steps 412-414. If there is a partial match, that is, some items are found either matching the needs list or the availability list, then the partial match results are saved while other domains are searched as described below. Once a complete match is found across multiple bartering domains, then the saved results are displayed to the user and processing continues as shown in steps 411-414. Otherwise, in other embodiments, each partial match is displayed to the user as processing continues as shown in steps 411-414.

A match between a needs list and other offer lists will result if i) there is a finding of some offer that satisfies the current needs—offer lists; or ii) the user foregoes one or more needs; or iii) the user includes money or barter dollars. When the needs list is matched by one or more items on an offer list, then the matching process is done. All of the users in the matching process are notified. If they all agree, the bartering transaction is completed. Otherwise, if they do not all agree, further matching is attempted.

Any further matching may require finding a match for near equivalence in items. For example, a user can specify a need such as “I want a baseball card of a member of a 1934 Yankee team.” The bartering system generates the corresponding bartering protocol language such as in XML. The bartering system is also enabled to barter or find matches across differing bartering systems where the representations of the needs and offers are different. If the bartering system does not find a match for the 1934 team, the system may find a match for a 1936 team. The bartering system does an analysis to appropriately prioritize the found near equivalent match and assigns a barter value.

As such, the bartering system of the present invention attempts to match a user's needs list and availability list of the offers that the user has made with the availability of products and services and the needs of other users. The matching is performed based on the priority of the items and/or choices.

The foregoing description of the preferred embodiments of the invention has been presented for the purposes of illustration and description. It is not intended to be exhaustive or to limit the invention to the precise form disclosed. Many modification and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for carrying out a bartering system over a network, comprising:
receiving a needs list having at least one needed item a user desires to acquire;
receiving a priority indication for at least one of i) each of the at least one needed item, and ii) each group of at least one item;
constructing the needs list with the priority indication into a barter protocol language; and
searching available items for a match with each of the at least one needed item based upon the priority indication wherein higher priority indicated needed items are attempted to be matched before lower priority indicated needed items.

2. The method of claim 1 further comprising receiving an availability list having at least one available item the user desires to trade for the at least one needed item.

3. The method of claim 1 wherein searching available items is performed first within a same bartering system and performed second across a different bartering system if no match is found during the search within the same bartering system.

4. The method of claim 3 further comprising translating, before the searching is performed across the different bartering system, the needed items to at least one of i) a common barter protocol language, and ii) a different barter protocol language of the different bartering system.

5. The method of claim 1 wherein the needs list further comprises a range of near equivalent items with each near equivalent item having an associated priority indication indicating a user's desire to accept a given near equivalent item in lieu of a given needed item if a match for the given needed item is not found.

6. The method of claim 1 wherein the match is a direct match having a one to one correspondence.

7. The method of claim 1 wherein the match is a chained association involving the needs list and availability lists of a plurality of users.

8. The method of claim 1 wherein the priority indication for a given needed item is indicated by a monetary value that a user is willing to provide for the needed item to carry out a bartering transaction.

9. The method of claim 2 further comprising receiving a second priority indication for a given available item indicating a user's desire to use the given available item to carry out a bartering transaction.

10. The method of claim 9 wherein the second priority indication is indicated by a monetary value that the user is willing to accept for the given available item.

11. The method of claim 1 further comprising receiving a monetary value associated with each of the at least one needed item.

12. The method of claim 11 further comprising receiving a monetary value priority indication, associated with the received monetary value, wherein the monetary value priority indication indicates a user's willingness to vary a payment value for a given needed item from the monetary value.

13. The method of claim 2 further comprising receiving a monetary value associated with each of the at least one available item.

14. The method of claim 13 further comprising receiving a monetary value priority indication, associated with the received monetary value, wherein the monetary value priority indication indicates a user's willingness to vary a received value for a given available item from the monetary value.

15. The method of claim 11 wherein the monetary value is received from data provided by a rating agency.

16. The method of claim 13 wherein the monetary value is received from data provided by a rating agency.

17. The method of claim 1 wherein the barter protocol Language is in XML.

18. The method of claim 1 wherein each of the at least one needed item can be at least one of a physical item and a nonphysical item.

19. The method of claim 18 wherein each physical item and each nonphysical item has a corresponding representation mechanism within the barter protocol language.

20. The method of claim 18 wherein the nonphysical item represents a needed service.

21. The method of claim 2 wherein each of the at least one available item can be at least one of a physical item and a nonphysical item.

22. The method of claim 21 wherein the nonphysical item represents an available service.

23. The method of claim 2 further comprising indicating equivalency of at least one available item with at least one needed item.

24. The method of claim 2 further comprising finding a match for at least one given available item in consideration for a found match for at least one given needed item, wherein the at least one available item, and the at least one needed item are represented in terms of equivalency.

25. A barter protocol language comprising:
means for specifying a needs list of needed items for each one of a plurality of users;
means for specifying an availability list of available items for each one of the plurality of users;
means for specifying a priority indication for at least one of i) each needed item, and ii) each group of at least one item, indicating a corresponding user's priority for acquiring the needed item; and
means for specifying a range of near equivalent items, each near equivalent item having an associated priority indication indicating a user's desire to accept a given near equivalent item in lieu of a given needed item if a match for the given needed item cannot be found.

26. The barter protocol language of claim 25 wherein the means for specifying the availability list of available items further comprises means for indicating at least one available item for being utilized in acquiring at least one needed item.

27. The barter protocol language of claim 25 wherein the language is one of a markup language.

28. The barter protocol language of claim 27 wherein the mark up language is XML.

29. The barter protocol language of claim 25 wherein each needed item and each available item has a corresponding representation mechanism.

30. The barter protocol language of claim 25 wherein the needed items and available items can be physical items and nonphysical items.

31. The barter protocol language of claim 25 wherein the nonphysical items are representative of services.

32. A computer system having means for carrying out bartering over a network, comprising:
means for receiving a needs list having at least one needed item a user desires to acquire;
means for receiving a priority indication for at least one of i) each of the at least one needed item, and ii) each group of at least one needed item;
means for constructing the needs list with the priority indication into a barter protocol language; and
means for searching available items for a match with each of the at least one needed item based upon the priority indication wherein higher priority indicated needed items are attempted to be matched before lower priority indicated needed items.

33. The computer system of claim 32 further comprising means for receiving an availability list having at least one available item the user desires to trade for the at least one needed item.

34. The computer system of claim 32 wherein the means for searching available items is performed first within a same bartering system and performed second across a different bartering system if no match is found during the search within the same bartering system.

35. The computer system of claim 34 further comprising means for translating the needed items to at least one of i) a common barter protocol language, and ii) a different protocol language of the different bartering system before the searching is performed across the different bartering system.

36. The computer system of claim 32 wherein the needs list further comprises a range of near equivalent items with each near equivalent item having an associated priority indication indicating a user's desire to accept a given near equivalent item in lieu of a given needed item if a match for the given needed item is not found.

37. The computer system of claim 32 wherein the match is a direct match having a one to one correspondence.

38. The computer system of claim 32 wherein the match is a chained association involving the needs list and availability lists of a plurality of users.

39. The computer system of claim 33 further comprising means for enabling an indication of equivalency of at least one available item with at least one needed item.

40. The computer system of claim 33 wherein the means for searching further comprises means for finding a match for at least one given available item in consideration for a found match for at least one given needed item, wherein the at least one available item, and the at least one needed item are represented in terms of equivalency.

41. The computer system of claim 40 wherein the at least one given needed item and the at least one given available item are dissimilar items.
